(19) United States
(12) Patent Application Publication
(10) Pub. No.: US 2014/0310271 A1
(43) Pub. Date: Oct. 16, 2014

(54) PERSONALIZED PROGRAM SELECTION SYSTEM AND METHOD

(71) Applicants: Jiqiang Song, Beijing (CN); Tao Wang, Beijing (CN); Peng Wang, Beijing (CN); Wenlong Li, Beijing (CN); Qiang Li, Beijing (CN)

(72) Inventors: Jiqiang Song, Beijing (CN); Tao Wang, Beijing (CN); Peng Wang, Beijing (CN); Wenlong Li, Beijing (CN); Qiang Li, Beijing (CN)

(21) Appl. No.: 13/574,828

(22) PCT Filed: Apr. 11, 2011
(86) PCT No.: PCT/CN11/00620

§ 371 Date: Feb. 13, 2014

(51) Int. Cl. G06F 17/30

(52) U.S. Cl. CPC G06F 17/30867
USPC 707/732; 707/758

(57) ABSTRACT

A system and method for selecting a program to present to a consumer includes detecting facial regions in an image, detecting hand gestures in an image, identifying one or more consumer characteristics (mood, gender, age, hand gesture, etc.) of said consumer in the image, identifying one or more programs to present to the consumer based on a comparison of the consumer characteristics with a program database including a plurality of program profiles, and presenting a selected one of the identified program to the consumer on a media device.

### CROSS REFERENCE TO RELATED APPLICATIONS

This application is a U.S. national stage completion of International Application No. PCT/CN2011/000620 filed Apr. 11, 2011, the entire content of which is herein incorporated by reference.

### FIELD

The present disclosure relates to the field of data processing, and more particularly, to methods, apparatuses, and systems for selecting one or more programs based on face detection/tracking (e.g., facial expressions, gender, age, and/or face identification/recognition) as well as hand gesture recognition.

### BACKGROUND

Some recommendation systems regard a home television client (e.g., a set-top box (STB)) or Internet television, as an end user and collect watching history from it. Based on the overall watching history and correlations among programs, the recommendation system selects unwatched programs and pushes their introductions to the home television client. However, a disadvantage of this approach is that a home television client is often shared by multiple people. Therefore, a overall or merged watching history of several users does not necessarily reflect any one user's preference.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 illustrates one embodiment of a system for selecting and displaying programs to a consumer based on facial analysis of the consumer consistent with various embodiments of the present disclosure;

FIG. 2 illustrates one embodiment of a face detection module consistent with various embodiments of the present disclosure;

FIG. 3 illustrates one embodiment of a hand detection module consistent with various embodiments of the present disclosure;

FIG. 4 depicts images of a “thumb up” hand gesture (left hand) consistent with one embodiment of the present disclosure;

FIG. 5 illustrates one embodiment of a program selection module consistent with various embodiments of the present disclosure;

FIG. 6 is a flow diagram illustrating one embodiment for selecting and displaying a program consistent with the present disclosure; and

FIG. 7 is a flow diagram illustrating another embodiment for selecting and displaying a program consistent with the present disclosure.

### DETAILED DESCRIPTION

By way of an overview, the present disclosure is generally directed to a system, apparatus, and method for selecting one or more programs to present a consumer based on a comparison of consumer characteristics identified from one or more images with a program database of program profiles. The consumer characteristics may be identified from the image(s) using facial analysis and/or hand gesture analysis. The system may generally include a camera for capturing one or more images of a consumer, a face detection module and a hand detection module configured to analyze the image(s) to determine one or more characteristics of the consumer, and a program selection module configured to select a program to provide to the consumer based on a comparison of consumer characteristics identified from the image(s) with a program database of program profiles. As used herein, the term “program” is intended to mean any television content including one-off broadcasts, a television series, and a television movie (e.g., made-for-TV movie and cinema movie broadcasted on television).

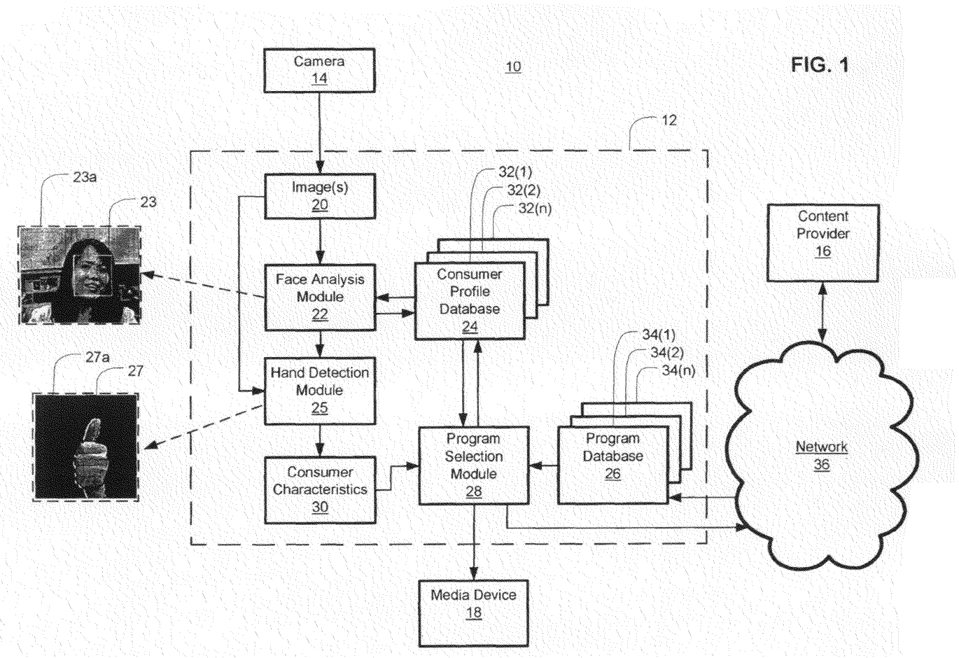

Turning now to FIG. 1, one embodiment of a system 10 consistent with the present disclosure is generally illustrated. The system 10 includes a program selection system 12, camera 14, a content provider 16, and a media device 18. As discussed in greater detail herein, the program selection system 12 is configured identify at least one consumer characteristic from one or more images 20 captured by the camera 14 and to select a program from the media provider 16 for presentation to the consumer on the media device 18.

In particular, the program selection system 12 includes a face detection module 22, a hand detection module 25, a consumer profile database 24, a program database 26, and a program selection module 28. The face detection module 22 is configured to receive one or more digital images 20 captured by at least one camera 14. The camera 20 includes any device (known or later discovered) for capturing digital images 20 representative of an environment that includes one or more persons, and may have adequate resolution for face analysis of the one or more persons in the environment as described herein. For example, the camera 20 may include a still camera (i.e., a camera configured to capture still photographs) or a video camera (i.e., a camera configured to capture a plurality of moving images in a plurality of frames). The camera 20 may be configured to with the light of the visible spectrum or with other portions of the electromagnetic spectrum (e.g., but not limited to, the infrared spectrum, ultraviolet spectrum, etc.). The camera 20 may include, for example, a web camera (as may be associated with a personal computer and/or TV monitor), handheld device camera (e.g., cell phone camera, smart phone camera (e.g., camera associated with the iPhone®, Trio®, Blackberry®, etc.), laptop computer camera, tablet computer (e.g., but not limited to, iPad®, Galaxy Tab®, and the like), etc.

The face detection module 22 is configured to identify a face and/or face region (e.g., as represented by the rectangular box 23 in the inset 23b referenced by the dotted line) within the image(s) 20 and determine one or more characteristics of the consumer (i.e., consumer characteristics 30). While the face detection module 22 may use a marker-based approach (i.e., one or more markers applied to a consumer's face), in some embodiments, the face detection module 22 may utilize a markerless-based approach. For example, the face detection module 22 may include custom, proprietary, known and/or after-developed face recognition code (or instruction sets), hardware, and/or firmware that are generally well-defined and operable to receive a standard format image (e.g., but not limited to, a RGB color image) and identify, at least to a certain extent, a face in the image.

In addition, the face detection module 22 may also include custom, proprietary, known and/or after-developed facial characteristics code (or instruction sets) that are generally well-defined and operable to receive a standard format image (e.g., but not limited to, a RGB color image) and identify, at least to a certain extent, one or more facial characteristics in the image. Such known facial characteristics systems include, but are not limited to, standard Viola-Jones boosting cascade framework, which may be found in the public Open Source Computer Vision (OpenCV™) package. As discussed in greater detail herein, consumer characteristics 30 may include, but are not limited to, consumer identity (e.g., an identifier associated with a consumer) and/or facial characteristics (e.g., but not limited to, consumer age, consumer age classification (e.g., child or adult), consumer gender, consumer race,), and/or consumer expression identification (e.g., happy, sad, smiling, frown, surprised, excited, etc.)).

The face detection module 22 may compare the image 22 (e.g., the facial pattern corresponding to the face 23 in the image 20) to the consumer profiles 32(1)-32(n) (hereinafter referred to individually as “a consumer profile 32”) in the consumer profile database 24 to identify the consumer. If no matches are found after searching the consumer profile database 24, the face detection module 22 may be configured to create a new consumer profile 32 based on the face 23 in the captured image 20.

The face detection module 22 may be configured to identify a face 23 by extracting landmarks or features from the image 20 of the subject's face 23. For example, the face detection module 22 may analyze the relative position, size, and/or shape of the eyes, nose, cheekbones, and jaw, for example, to form a facial pattern. The face detection module 22 may use the identified facial pattern to search the consumer profiles 32(1)-32(n) for other images with matching facial pattern to identify the consumer. The comparison may be based on template matching techniques applied to a set of salient facial features, providing a sort of compressed face representation. Such known face recognition systems may be based on, but are not limited to, geometric techniques (which looks at distinguishing features) and/or photometric techniques (which is a statistical approach that distill an image into values and comparing the values with templates to eliminate variances).

While not an exhaustive list, the face detection module 22 may utilize Principal Component Analysis with Eigenface, Linear Discriminate Analysis, Elastic Bunch Graph Matching fisherface, the Hidden Markov model, and the neuronal motivated dynamic link matching.

According to one embodiment, a consumer may generate and register a consumer profile 32 with the program selection system 12. Alternatively (or in addition), one or more of the consumer profiles 32(1)-32(n) may be generated and/or updated by the program selection module 28 as discussed herein. Each consumer profile 32 includes a consumer identifier and consumer demographical data. The consumer identifier may include data configured to uniquely identify a consumer based on the face recognition techniques used by the face detection module 22 as described herein (such as, but not limited to, pattern recognition and the like). The consumer demographical data represents certain characteristics and/or preferences of the consumer. For example, consumer demographical data may include preferences for certain types of goods or services, gender, race, age or age classification, income, disabilities, mobility (in terms of travel time to work or number of vehicles available), educational attainment, home ownership or rental, employment status, and/or location. Consumer demographical data may also include preferences for certain types/categories of advertising techniques. Examples of types/categories of advertising techniques may include, but are not limited to, comedy, drama, reality-based advertising, and the like.

The hand detection module 25 may be generally configured to process one or more images 20 to identify a hand and/or hand gesture (e.g., hand gesture 27 in the inset 27a referenced by the dotted line) within the image(s) 20. As discussed herein, examples of hand gestures 27 that may be captured by the camera 14 include a “stop” hand, a “thumb right” hand, a “thumb left” hand, a “thumb up” hand, a “thumb down” hand and an “OK sign” hand. Of course, these are only examples of the types of hand gestures 27 that may be used with the present disclosure, and these are not intended to be an exhaustive list of the types of hand gestures that may be used with the present disclosure.

The hand detection module 25 may include custom, proprietary, known and/or after-developed hand recognition code (or instruction sets) that are generally well-defined and operable to receive a standard format image (e.g., RGB color image) and identify, at least to a certain extent, a hand in the image. Such known hand detection systems include computer vision systems for object recognition, 3-D reconstruction systems, 2D Haar wavelet response systems (and derivatives thereof), skin-color based method, shape-based detection, Speed-Up Robust Features (SURF) facial recognition schemes (and extension and/or derivatives thereof), etc.

The results of the hand detection module 25 may, in turn, be included in the consumer characteristics 30 which are received by the program selection module 28. The consumer characteristics 30 may, therefore, include the results of the face detection module 22 and/or the hand detection module 25.

The program selection module 28 may be configured to compare the consumer characteristics 30 (and any consumer demographical data, if an identity of the consumer is known) with the program profiles 34(1)-34(n) (hereinafter referred to individually as “a program profile 34”) stored in the program database 26. As described in greater detail herein, the program selection module 28 may use various statistical analysis techniques for selecting one or more programs based on the comparison between the consumer characteristics 30 and the program profiles 34(1)-34(n). For example, the program selection module 28 may utilize a weighted average statistical analysis (including, but not limited to, a weighted arithmetic mean, weighted geometric mean, and/or a weighted harmonic mean).

The program selection module 28 may update a consumer profile 32 based on the consumer characteristics 30 and a particular program and/or program profile 32 currently being viewed. For example, the program selection module 28 may update a consumer profile 32 to reflect a consumer's reaction (e.g., favorable, unfavorable, etc.) as identified in the consumer characteristics 30 to a particular program and the program's corresponding program profile 32. The consumer's reaction may be directly correlated to a hand gesture 27 detected by the hand detection module 25.

The program selection module 28 may also be configured to transmit all or a portion of the consumer profiles 32(1)-32(n) to the content provider 16. As used herein, the term “content provider” includes broadcasters, advertising agencies, production studios, and advertisers. The content provider 16 may then utilize this information to develop future programs based on a likely audience. For example, the program selection module 28 may be configured to encrypt and packetize data corresponding to the consumer profiles 32(1)-32(n) for transmission across a network 36 to the content provider 16. It may be appreciated that the network 36 may include wired and/or wireless communications paths such as, but not limited to, the Internet, a satellite path, a fiber-optic path, a cable path, or any other suitable wired or wireless communications path or combination of such paths.

The program profiles 34(1)-34(n) may be provided by the content provider 16 (for example, across the network 36), and may include a program identifier/classifier and/or program demographical parameters. The program identifier/classifier may be used to identify and/or classify a particular program into one or more predefined categories. For example, a program identifier/classifier may be used to classify a particular program into a broad category such as, but not limited to, as a “comedy,” “home improvement,” “drama,” “reality-based,” “sports,” or the like. The program identifier/classifier may also/alternatively be used to classify a particular program into a narrower category such as, but not limited to, “baseball,” “football,” “game show,” “action movie,” “drama movie,” “comedy movie,” or the like. The program demographical parameters may include various demographical parameters such as, but not limited to, gender, race, age or age characteristic, income, disabilities, mobility (in terms of travel time to work or number of vehicles available), educational attainment, home ownership or rental, employment status, and/or location. The content provider 16 may weight and/or prioritize the program demographical parameters.

The media device 18 is configured to display a program from the content provider 16 which has been selected by the program selection system 12. The media device 18 may include any type of display including, but not limited to, a television, an electronic billboard, a digital signage, a personal computer (e.g., desktop, laptop, netbook, tablet, etc.), a mobile phone (e.g., a smart phone or the like), a music player, or the like.

The program selection system 12 (or a part thereof) may be integrated into a set-top box (STB) including, but not limited to, a cable STB, a satellite STB, an IP-STB, terrestrial STB, integrated access device (IAD), digital video recorder (DVR), smart phone (e.g., but not limited to, iPhone®, Trio®, Blackberry®, Droid®, etc.), a personal computer (including, but not limited to, a desktop computer, laptop computer, netbook computer, tablet computer (e.g., but not limited to, iPad®, Galazy Tab®, and the like), etc.

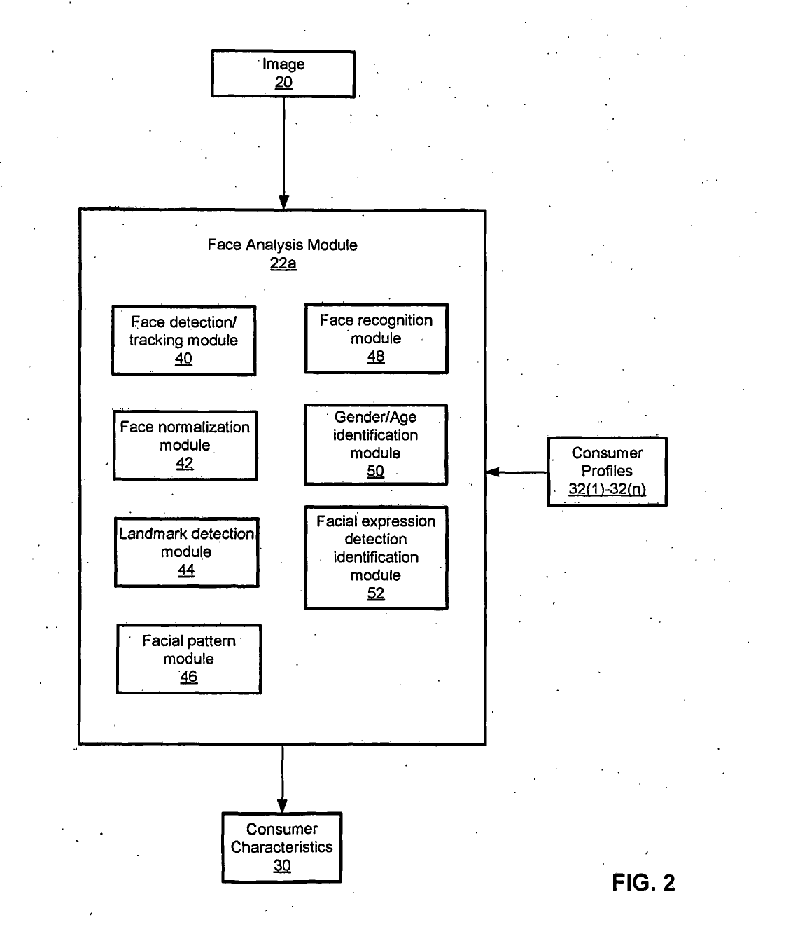

Turning now to FIG. 2, one embodiment of a face detection module 22a consistent with the present disclosure is generally illustrated. The face detection module 22a may be configured to receive an image 20 and identify, at least to a certain extent, a face (or multiple faces) in the image 20. The face detection module 22a may also be configured to identify, at least to a certain extent, one or more facial characteristics in the image 20 and determine one or more consumer characteristics 30 (which may also include hand gesture information as discussed herein). The consumer characteristics 30 may be generated, at least in part, based on one or more of the facial parameters identified by the face detection module 22a as discussed herein. The consumer characteristics 30 may include, but are not limited to, a consumer identity (e.g., an identifier associated with a consumer) and/or facial characteristics (e.g., but not limited to, consumer age, consumer age classification (e.g., child or adult), consumer gender, consumer race,), and/or consumer expression identification (e.g., happy, sad, smiling, frown, surprised, excited, etc.)).

For example, one embodiment of the face detection module 22a may include a face detection/tracking module 40, a landmark detection module 44, a face normalization module 42, and a facial pattern module 46. The face detection/tracking module 40 may include custom, proprietary, known and/or after-developed face tracking code (or instruction sets) that is generally well-defined and operable to detect and identify, at least to a certain extent, the size and location of human faces in a still image or video stream received from the camera. Such known face detection/tracking systems include, for example, the techniques of Viola and Jones, published as Paul Viola and Michael Jones, Rapid Object Detection using a Boosted Cascade of Simple Features, Accepted Conference on Computer Vision and Pattern Recognition, 2001. These techniques use a cascade of Adaptive Boosting (AdaBoost) classifiers to detect a face by scanning a window exhaustively over an image. The face detection/tracking module 40 may also track an identified face or facial region across multiple images 20.

The face normalization module 42 may include custom, proprietary, known and/or after-developed face normalization code (or instruction sets) that is generally well-defined and operable to normalize the identified face in the image 20. For example, the face normalization module 42 may be configured to rotate the image to align the eyes (if the coordinates of the eyes are known), crop the image to a smaller size generally corresponding the size of the face, scale the image to make the distance between the eyes constant, apply a mask that zeros out pixels not in an oval that contains a typical face, histogram equalize the image to smooth the distribution of gray values for the non-masked pixels, and/or normalize the image so the non-masked pixels have mean zero and standard deviation one.

The landmark detection module 44 may include custom, proprietary, known and/or after-developed landmark detection code (or instruction sets) that is generally well-defined and operable to detect and identify, at least to a certain extent, the various facial features of the faces in the image 20. Implicit in landmark detection is that the face has already been detected, at least to some extent. Some degree of localization (for example, a course localization) may have been performed (for example, by the face normalization module 42) to identify/focus on the zones/areas of the image 20 where landmarks can potentially be found. For example, the landmark detection module 44 may be based on heuristic analysis and may be configured to identify and/or analyze the relative position, size, and/or shape of the eyes (and/or the corner of the eyes), nose (e.g., the tip of the nose), chin (e.g. tip of the chin), cheekbones, and jaw. Such known landmark detection systems include a six-facial points (i.e., the eye-corners from left/right eyes, and mouth corners) and six facial points (i.e., green points). The eye-corners and mouth corners may also be detected using Viola-Jones based classifier. Geometry constraints may be incorporated to the six facial points to reflect their geometry relationship.

The facial pattern module 46 may include custom, proprietary, known and/or after-developed facial pattern code (or instruction sets) that is generally well-defined and operable to identify and/or generate a facial pattern based on the identified facial landmarks in the image 20. As may be appreciated, the facial pattern module 46 may be considered a portion of the face detection/tracking module 40.

The face detection module 22a may include one or more of a face recognition module 48, gender/age identification module 50, and/or a facial expression detection module 52. In particular, the face recognition module 48 may include custom, proprietary, known and/or after-developed facial identification code (or instruction sets) that is generally well-defined and operable to match a facial pattern with a corresponding facial pattern stored in a database. For example, the face recognition module 48 may be configured to compare the facial pattern identified by the facial pattern module 46, and compare the identified facial pattern with the facial patterns associated with the consumer profiles 32(1)-32(n) in the consumer profile database 24 to determine an identity of the consumer in the image 20. The face recognition module 48 may compare the patterns utilizing a geometric analysis (which looks at distinguishing features) and/or a photometric analysis (which is a statistical approach that distill an image into values and comparing the values with templates to eliminate variances). Some face recognition techniques include, but are not limited to, Principal Component Analysis with eigenface (and derivatives thereof), Linear Discriminate Analysis (and derivatives thereof), Elastic Bunch Graph Matching fisherface (and derivatives thereof), the Hidden Markov model (and derivatives thereof), and the neuronal motivated dynamic link matching.

The face recognition module 48 may be configured to cause a new consumer profile 32 to be created in the consumer profile database 24 if a match with an existing consumer profile 32 is not found. For example, the face recognition module 48 may be configured to transfer data representing the identified consumer characteristics 30 to the consumer profile database 24. An identifier may then be created which is associated with a new consumer profile 32.

The gender/age identification module 50 may include custom, proprietary, known and/or after-developed gender and/or age identification code (or instruction sets) that is generally well-defined and operable to detect and identify the gender of the person in the image 20 and/or detect and identify, at least to a certain extent, the age of the person in the image 20. For example, the gender/age identification module 50 may be configured to analyze the facial pattern generated from the image 20 to identify which gender the person is in the image 20. The identified facial pattern may be compared to a gender database which includes correlation between various facial patterns and gender.

The gender/age identification module 50 may also be configured to determine and/or approximate a person's age and/or age classification in the image 20. For example, the gender/age identification module 50 may be configured to compare the identified facial pattern to an age database which includes correlation between various facial patterns and age. The age database may be configured approximate an actual age of the person and/or classify the person into one or more age groups. Examples of age groups may include, but are not limited to, adult, child, teenager, elderly/senior, etc.

The facial expression detection module 52 may include custom, proprietary, known and/or after-developed facial expression detection and/or identification code (or instruction sets) that is generally well-defined and operable to detect and/or identify facial expressions of the person in the image 20. For example, the facial expression detection module 52 may determine size and/or position of the facial features (e.g., eyes, mouth, cheeks, teeth, etc.) and compare the facial features to a facial feature database which includes a plurality of sample facial features with corresponding facial feature classifications (e.g., smiling, frown, excited, sad, etc.).

In one example embodiment, one or more aspects of the face detection module 22a (e.g., but not limited to, face detection/tracking module 40, recognition module 48, gender/age module 50, and/or facial expression detection module 52) may use a multilayer perceptron (MLP) model that iteratively maps one or more inputs onto one or more outputs. The general framework for the MLP model is known and well-defined, and generally includes a feedforward neural network that improves on a standard linear preceptron model by distinguishing data that is not linearly separable. In this example, the inputs to the MLP model may include one or more shape features generated by the landmark detection module 44. The MLP model may include an input layer defined by a plurality of input nodes. Each node may comprise a shape feature of the face image. The MLP model may also include a “hidden” or iterative layer defined by “hidden” neurons. Typically, M is less than N, and each node of the input layer is connected to each neuron in the “hidden” layer.

The MLP model may also includes an output layer defined by a plurality of output neurons. Each output neuron may be connected to each neuron in the “hidden” layer. An output neuron, generally, represents a probability of a predefined output. The number of outputs may be predefined and, in the context of this disclosure, may match the number of faces and/or face gestures that may be identified by the face detection/tracking module 40, face recognition module 48, gender/age module 50, and/or facial expression detection module 52. Thus, for example, each output neuron may indicate the probability of a match of the face and/or face gesture images, and the last output is indicative of the greatest probability.

In each layer of the MLP model, given the inputs xⱼ of a layer m, the outputs Lᵢ of the layer n+1 are computed as:

$$\begin{matrix}{u}_{i} = {\sum }_{j} ( {w}_{i , j}^{n + 1} \cdot {x}_{j} ) + {w}_{i , bias}^{n + 1} & EQ . 1 \\ {y}_{i} = f ( {u}_{i} ) & EQ . 2\end{matrix}$$

The f function, assuming a sigmoid activation function, may be defined as:

ƒ(x)=β·(1−e^{-αx})/(1+e^{-αx}) EQ. 3

The MLP model may be enabled to learn using backpropogation techniques, which may be used to generate the parameters α, β are learned from the training procedure. Each input xⱼ may be weighted, or biased, indicating a stronger indication of face and/or face gesture type. The MLP model may also include a training process which may include, for example, identifying known faces and/or face gestures so that the MLP model can “target” these known faces and/or face gestures during each iteration.

The output(s) of the face detection/tracking module 40, face recognition module 48, gender/age module 50, and/or facial expression detection module 52 may include a signal or data set indicative of the type of face and/or face gesture identified. This, in turn may be used to generate a portion of the consumer characteristic data/signal 30. The consumer characteristics 30 generated by the face detection module 22a may be passed to the hand detection module 25, which may detect a hand (if present) in the image(s) 20, and update the consumer characteristics 30, which may be used to select one or more program profiles 32(1)-32(n) as discussed herein.

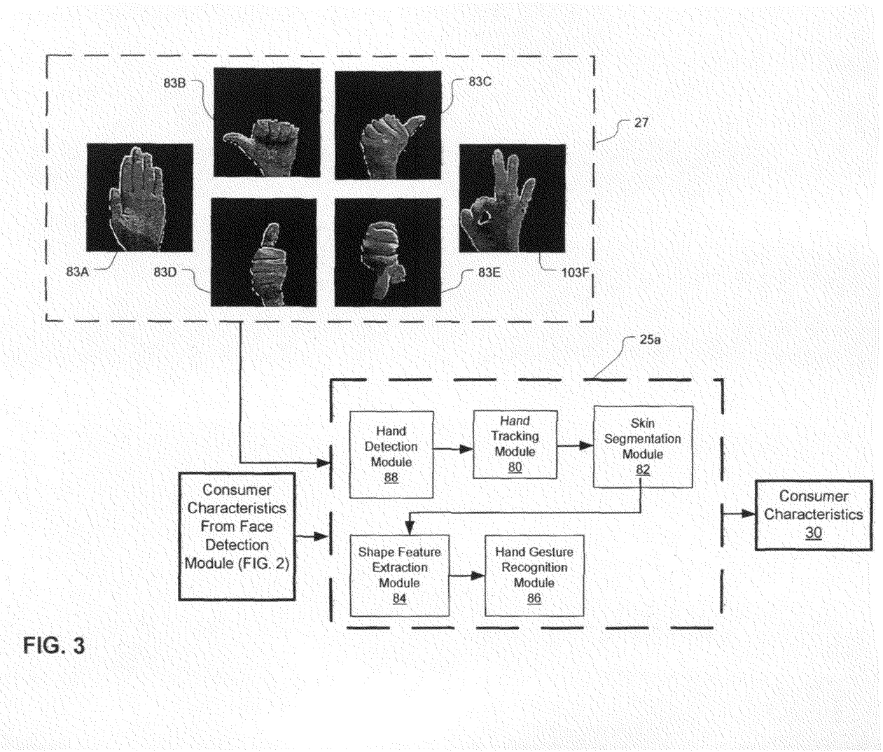

Turning now to FIG. 3, one embodiment of a hand detection module 25a is generally illustrated. The hand detection module 25a may be generally configured to track a hand region (defined by the hand detection module 88) through a series of images (e.g., video frames at 24 frames per second). The hand tracking module 80 may include custom, proprietary, known and/or after-developed tracking code (or instruction sets) that are generally well-defined and operable to receive a series of images (e.g., RGB color images) and track, at least to a certain extent, a hand in the series of images. Such known tracking systems include particle filtering, optical flow, Kalman filtering, etc., each of which may utilize edge analysis, sum-of-square-difference analysis, feature point analysis, mean-shifting techniques (or derivatives thereof), etc.

The hand detection module 25a may also include a skin segmentation module 82 generally configured to identify the skin colors of a hand within a hand region of an image (defined by the hand detection module 88 and/or hand tracking module 80). The skin segmentation module 82 may include custom, proprietary, known and/or after-developed skin identification code (or instruction sets) that are generally well-defined and operable to distinguish skin tones or colors from other areas of the hand region. Such known skin identification systems include thresholding on hue-saturation color components, HSV color statistics, color-texture modeling, etc. In one example embodiment, the skin segmentation module 82 may use a generalized statistical skin color model, such as a multi-variable Gaussian model (and derivatives thereof).

The hand detection module 25a may also include a shape feature extraction module 84 generally configured to identify one or more shape features of the hand in the binary image generated by the skin segmentation module 82. The shape features, generally, include intrinsic properties and/or “markers” of the hand shape in the binary image, and may be used to improve the efficiency hand gesture recognition module 86 to identify a hand gesture in the image. Shape features may include, for example, eccentricity, compactness, orientation, rectangularity, width center, height center, the number of defects, difference between left and right parts, difference between top and bottom parts, etc.

For example, the hand gesture recognition module 86 may be generally configured to identify the hand gesture with a hand region of an image 27, based on the hand shape features identified by the shape feature extraction module 84, for example, as described below. The hand gesture recognition module 86 may include custom, proprietary, known and/or after-developed skin identification code (or instruction sets) that are generally well-defined and operable to identify a hand gesture within an image. Known hand gesture recognition systems that may be used according to the teachings of the present disclosure include, for example, pattern recognition systems, Perseus models (and derivatives thereof), Hidden Markov models (and derivatives thereof), support vector machine, linear discriminate analysis, decision tree, etc. For example, the hand gesture recognition module 86 may use a multilayer perceptron (MLP) model, or derivative thereof, that iteratively maps one or more inputs onto one or more outputs. The general framework for the MLP model is known and well-defined, and generally includes a feedforward neural network that improves on a standard linear preceptron model by distinguishing data that is not linearly separable. In this example, the inputs to the MLP model may include one or more shape features generated by the shape feature extraction module 84 as described above.

Example of hand gestures 27 that may be captured by the camera 14 include a “stop” hand 83A, a “thumb right” hand 83B, a “thumb left” hand 83C, a “thumb up” hand 83D, a “thumb down” hand 83E and an “OK sign” hand 83F. Of course, images 83A-83F are only examples of the types of hand gestures that may be used with the present disclosure, and these are not intended to be an exhaustive list of the types of hand gestures that may be used with the present disclosure.

The output of the hand gesture recognition module 86 may include a signal or data set indicative of the type of hand gesture identified. This, in turn, may be used to generate a portion of the consumer characteristic data 30.

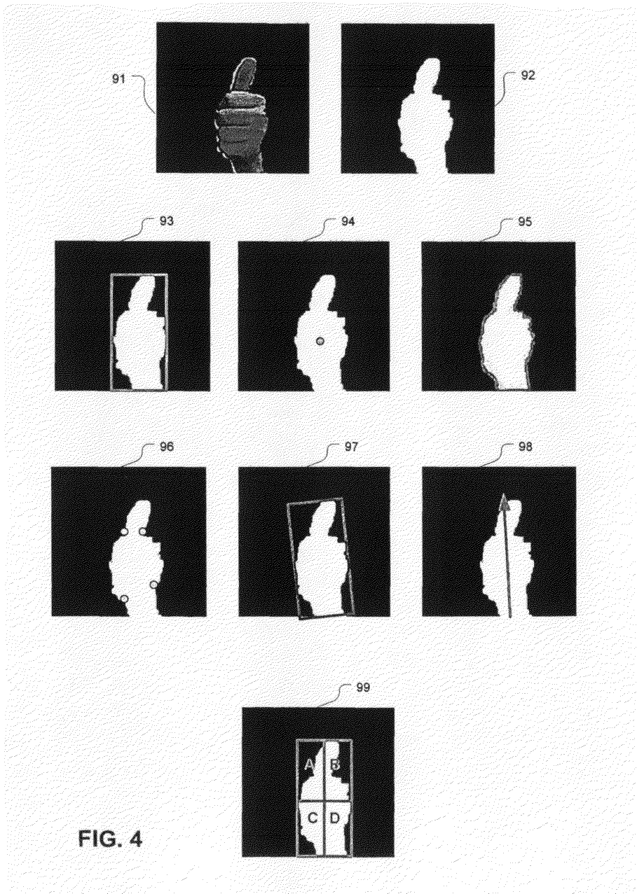

FIG. 4 depicts images of a “thumb up” hand gesture (left hand) consistent with one embodiment of the present disclosure. The original image 91 (corresponding to image 27 in FIG. 1) is an RGB format color image. A binary image 92, generated by the skin segmentation module 82 of FIG. 3, is depicted showing non-skin pixels as black and skin pixels as white. The shape feature extraction module 84 of FIG. 3 may be configured to generate a boundary shape that surrounds, or partially surrounds the hand in the binary image, as depicted in image 93. The bounding shape may be rectangular, as depicted, and in other embodiments, the bounding shape may include a circle, oval, square and/or other regular or irregular shape, depending on, for example, the geometry of the hand in the image. Based on the bounding shape, shape feature extraction module 84 may be configured to determine the eccentricity, rectangularity, compactness and center of the image within the boundary shape, and also determine the area as a count of the white pixels in the image and the perimeter as a count of the white pixels at the edge (e.g., the white pixels that are directly next to black pixels). Eccentricity may be determined as the width of the bounding shape times the height of the bounding shape; rectangularity may be determined as the area divided by the area of the bounding box; and compactness may be determined as the perimeter (squared) divided by the area. In addition, the shape feature extraction module 84 may be configured to determine the center of the hand within the bounding shape, as depicted in image 94. The center may be determined as the middle of the bounding shape along both a horizontal axis (e.g., x-axis) and a vertical axis (e.g., y-axis).

The shape feature extraction module 84 may also be configured to identify the contour of the hand, as depicted in image 95. The contour may be identified by determining the transition between adjacent pixels from a binary 1 (white) to a binary 0 (black), where the pixels on the boundary define the contour. The shape feature extraction module 84 may also be configured to determine the number of defects that lay along the contour, and four such defects are depicted in image 96. The defects may be defined as local defect of convexity, e.g., the pixel locations where a concave region has one or more convex pixels. The shape feature extraction module 84 may also be configured to determine a minimum shape that enclosed the contour (95), as depicted in image 97. The minimum shape (a rectangle in this example) may be defined by the left-most, right-most, highest and lowest white pixels in the image, and may be slanted with respect to the axes of the image, as depicted. The angle of the minimum shape with respect to the horizontal axis of the image may be determined by the shape feature extraction module 84. In addition, the shape feature extraction module 84 may determine the minimum box width to height ratio defined as the minimum box width divided by the minimum box height. Based on the angle of the minimum shape with respect to the horizontal axis, the shape feature extraction module 84 may also determine the orientation of the hand within the image. Here, the orientation may be defined as line taken from the center of, and normal to, the width of the minimum shape, as depicted in image 98.

The shape feature extraction module 84 may also be configured to divide the boundary shape (image 93) into a plurality of substantially equal segments, as depicted in image 99. In this example, the boundary shape is divided into four equal rectangular sub-blocks, labeled A, B, C and D. Based on the sub-blocks, the shape feature extraction module 84 may also be configured to determine the number of white pixels in each sub-block, the difference between the number of pixels in the left and right halves of the image (e.g., (A+C)−(B+D)), and the difference between the number of pixels in the top and bottom halves of the image (e.g., (A+B)−(C+D)).

The foregoing examples of the operations of the shape feature extraction module 84 and the described shape features are not intended to be an exhaustive list, nor would all the shape features described above be useful or necessary in determining the hand gesture depicted in the image. Thus, in some embodiments and for other hand gestures, additional shape features may be determined or a subset of the described shape features may be determined.

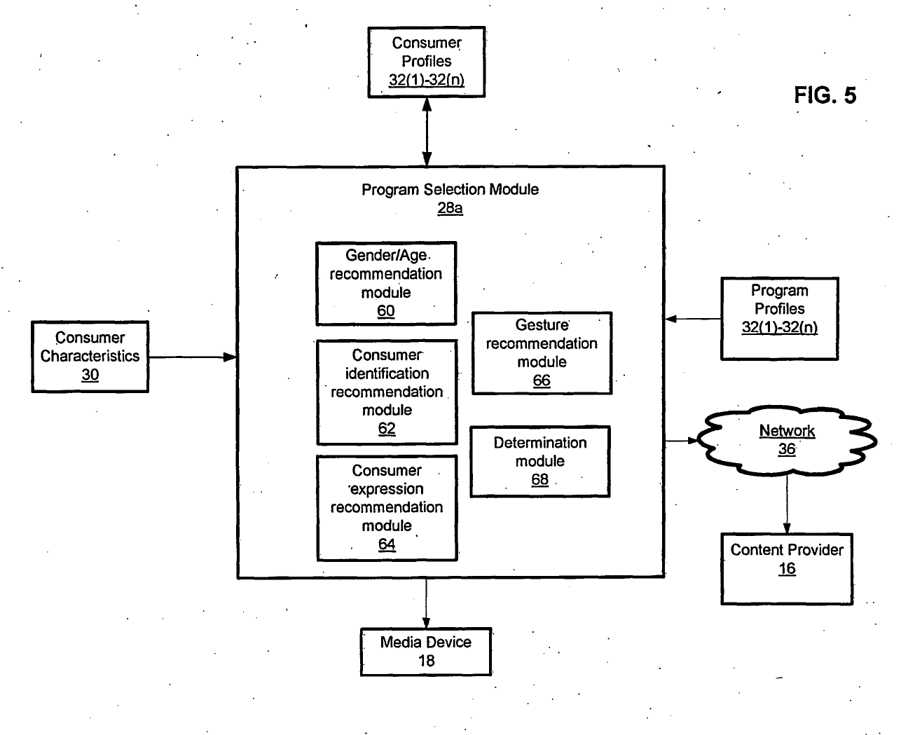

Turning now to FIG. 5, one embodiment of a program selection module 28a consistent with the present disclosure is generally illustrated. The program selection module 28a is configured to select at least one program from the program database 26 based, at least in part, on a comparison of the program profiles 34(1)-34(n) in the program database 26 with the consumer characteristic data 30 identified by the face detection module 22 and/or the hand detection module 25. The program selection module 28a may use the characteristic data 30 to identify a consumer profile 32 from the consumer profile database 24. The consumer profile 32 may also include parameters used by the program selection module 28a in the selection of a program as described herein. The program selection module 28a may update and/or create a consumer profile 32 in the consumer profile database 24 and associate the consumer profile 32 with the characteristic data 30.

According to one embodiment, the program selection module 28a includes one or more recommendation modules (for example, a gender and/or age recommendation module 60, a consumer identification recommendation module 62, a consumer expression recommendation module 64, and/or a gesture recommendation module 66) and a determination module 68. As discussed herein, the determination module 68 is configured to select one or more programs based on a collective analysis of the recommendation modules 60, 62, 64, and 66.

The gender and/or age recommendation module 60 may be configured to identity and/or rank one or more programs from the program database 26 based on, at least in part, a comparison of program profiles 32(1)-32(n) with the consumer's age (or approximation thereof), age classification/grouping (e.g., adult, child, teenager, senior, or like) and/or gender (hereinafter collectively referred to as “age/gender data”). For example, the gender and/or age recommendation module 60 may identify consumer age/gender data from the characteristic data 30 and/or from an identified consumer profile 32 as discussed herein. The program profiles 32(1)-32(n) may also include data representing a classification, ranking, and/or weighting of the relevancy of each of the programs with respect to one or more types of age/gender data (i.e., a target audience) as supplied by the content provider and/or the advertising agency. The gender and/or age recommendation module 60 may then compare the consumer age/gender data with the advertising profiles 32(1)-32(n) to identify and/or rank one or more programs.

The consumer identification recommendation module 62 may be configured to identity and/or rank one or more programs from the program database 26 based on, at least in part, a comparison of program profiles 32(1)-32(n) with an identified consumer profile. For example, the consumer identification recommendation module 62 may identify consumer preferences and/or habits based on previous viewing history and reactions thereto associated with the identified consumer profile 32 as discussed herein. Consumer preferences/habits may include, but are not limited to, how long a consumer watches a particular program (i.e., program watching time), what types of programs the consumer watches, the day, day of the week, month, and/or time that a consumer watches a program, and/or the consumer's facial expressions (smile, frown, excited, gaze, etc.), and the like. The consumer identification recommendation module 62 may also store identified consumer preferences/habits with an identified consumer profile 32 for later use. The consumer identification recommendation module 62 may therefore compare a consumer history associated with a particular consumer profile 32 to determine which program profiles 32(1)-32(n) to recommend.

A prerequisite for the consumer identification recommendation module 62 to identify which programs to recommend is that a consumer must be identified with a particular, existing consumer profile 32. The identification, however, does not necessarily require that the content selection module 28a knows consumer's name or username, but rather may be anonymous in the sense that the content selection module 28a merely needs to be able to recognize/associate the consumer in the image 20 to an associated consumer profile 32 in the consumer profile database 24. Therefore, while a consumer may register himself with an associated consumer profile 32, this is not a requirement.

The consumer expression recommendation module 64 is configured to compare the consumer expressions in the consumer characteristic data 30 to the program profile 32 associated with the program that the consumer is currently viewing. For example, if the consumer characteristic data 30 indicates that the consumer is smiling or gazing (e.g., as determined by the facial expression detection module 52), the consumer expression recommendation module 64 may infer that the program profile 32 of the program that the consumer is watching is favorable. The consumer expression recommendation module 64 may therefore identify one or more additional program profiles 32(1)-32(n) which are similar to the program profile 32 of the program being watched. Additionally, the consumer expression recommendation module 64 may also update an identified consumer profile 32 (assuming a consumer profile 32 has been identified).

The gesture recommendation module 66 is configured to compare the hand gesture information in the consumer characteristic data 30 to the program file 32 associated with associated with the program that the consumer is currently viewing. For example, if the consumer characteristic data 30 indicates that the consumer is giving a thumbs up (e.g., as determined by the hand detection module 25), the gesture recommendation module 66 may infer that the program profile 32 of the program that the consumer is watching is favorable. The gesture recommendation module 66 may therefore identify one or more additional program profiles 32(1)-32(n) which are similar to the program profile 32 of the program being watched. Similarly, if the consumer characteristic data 30 indicates that the consumer is giving a thumbs down, the gesture recommendation module 66 may infer that the program profile 32 of the program that the consumer is watching is not favorable and may therefore reduce and/or preclude other program profiles 32(1)-32(n) which are similar to the program profile 32 of the program being watched. Additionally, the gesture recommendation module 66 may also update an identified consumer profile 32 (assuming a consumer profile 32 has been identified) with the identified correlation between the viewed program profile 32.

The determination module 68 may be configured to weigh and/or rank the recommendations from the various recommendation modules 60, 62, 64, and 66. For example, the determination module 68 may select one or more programs based on a heuristic analysis, a best-fit type analysis, regression analysis, statistical inference, statistical induction, and/or inferential statistics on the program profiles 34 recommended by the recommendation modules 60, 62, 64, and 66 to identify and/or rank one or more program profiles 32 to present to the consumer. It should be appreciated that the determination module 68 does not necessarily have to consider all of the consumer data 30. In addition, the determination module 68 may compare the recommended program profiles 32 identified for a plurality of consumers simultaneously watching. For example, the determination module 68 may utilize different analysis techniques based on the number, age, gender, etc. of the plurality of consumers watching. For example, the determination module 68 may reduce and/or ignore one or more parameters and/or increase the relevancy of one or more parameters based on the characteristics of the group of consumers watching. By way of example, the determination module 68 may default to presenting programs for children if a child is identified, even if there are adults present. By way of further example, the determination module 68 may present programs for women if more women are detected than men.

Additionally, the determination module 68 may select program files 32 based on the overall hand gestures. For example, if the face detection module 22 determines the identity of the person currently viewing the display 18, the determination module 68 may select similar program profiles 32 based on the hand gestures detected by the hand detection module 25. The consumer therefore is able to rate his/her preference of the program being viewed, which may be used to select future programs. Of course, these examples are not exhaustive, and the determination module 68 may utilize other selection techniques and/or criterion.

According to one embodiment, the content selection module 28a may transmit a signal to the content provider 16 representing one or more selected programs to present to the consumer. The content provider 16 may then transmit a signal to the media device 18 with the corresponding program. Alternatively, the programs may be stored locally (e.g., in a memory associated with the media device 18 and/or the program selection system 12) and the content selection module 28a may be configured to cause the selected program to be presented on the media device 18.

The content selection module 28a may also be configured to transmit the collected consumer profile data (or a portion thereof) to the content provider 16. The content provider 16 may then resell this information and/or use the information to develop future programs based on a likely audience.

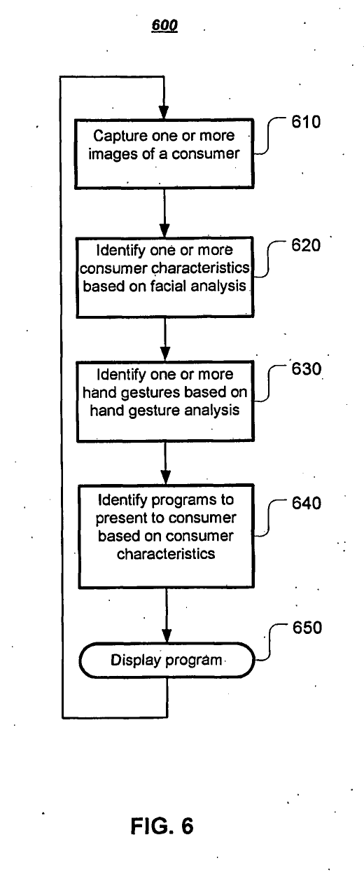

Turning now to FIG. 6, a flowchart illustrating one embodiment of a method 600 for selecting and displaying a program is illustrated. The method 600 includes capturing one or more images of a consumer (operation 610). The images may be captured using one or more cameras. A face and/or face region may be identified within the captured image and at least one consumer characteristics may be determined (operation 620). In particular, the image may be analyzed to determine one or more of the following consumer characteristics: the consumer's age, the consumer's age classification (e.g., child or adult), the consumer's gender, the consumer's race, the consumer's emotion identification (e.g., happy, sad, smiling, frown, surprised, excited, etc.), and/or the consumer's identity (e.g., an identifier associated with a consumer). For example, the method 600 may include comparing one or more face landmark patterns identified in the image to a set of consumer profiles stored in a consumer profile database to identify a particular consumer. If no match is found, the method 600 may include creating a new consumer profile in the consumer profile database.

The method 600 also includes identifying one or more hand gestures from a captured image (operation 630). The hand gesture may include, but is not limited to, a thumbs up, a thumbs down, or the like. Information representative of the identified hand gesture may be added to the consumer characteristics.

The method 600 further includes identifying one or more programs to present to the consumer based on the consumer characteristics (operation 640). For example, the method 600 may compare the consumer characteristics to a set of program profiles stored in a program database to identify a particular program to present to a consumer. Alternatively (or in addition), the method 600 may compare a consumer profile (and a corresponding set of consumer demographical data) to the program profiles to identify a particular program to present to a consumer. For example, the method 600 may use the consumer characteristics to identify a particular consumer profile stored in the consumer profile database.

The method 600 further includes displaying the selected program to the consumer (operation 650). The method 600 may then repeat itself. The method 600 may update a consumer profile in the consumer profile database based on the consumer characteristics related to a particular program being viewed. This information may be incorporated into the consumer profile stored in the consumer profile database and used for identifying future programs.

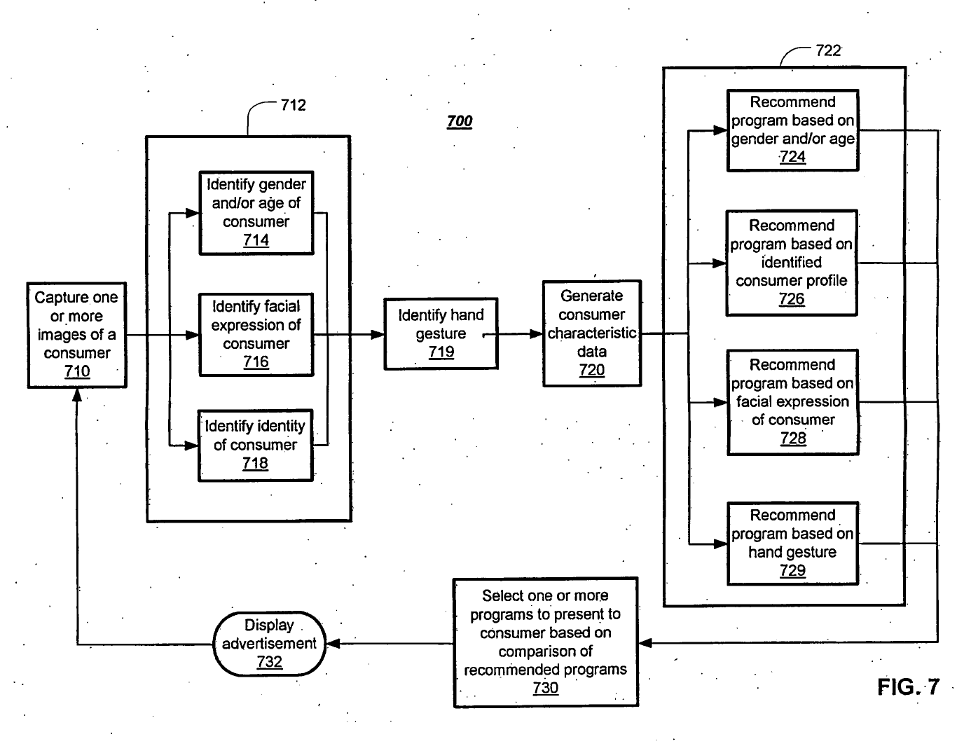

Referring now to FIG. 7, illustrates another flowchart of operations 700 for selecting and displaying a program based on a captured image of a consumer in a viewing environment. Operations according to this embodiment include capturing one or more images using one or more cameras (operation 710). Once the image has been captured, facial analysis is performed on the image (operation 512). Facial analysis 512 includes identifying the existence (or not) of a face or facial region in the captured image, and if a face/facial region is detected, then determining one or more characteristics related to the image. For example, the gender and/or age (or age classification) of the consumer may be identified (operation 714), the facial expressions of the consumer may be identified (operation 716), and/or identity of the consumer may be identified (operation 718).

The operation 700 also includes performing hand analysis on one or more images to identify and/or classify a hand gesture therein (operation 719). The hand gesture may include, but is not limited to, a thumbs up, a thumbs down, or the like. Information representative of the identified hand gesture may be added to the consumer characteristics.

Once facial analysis and hand gesture analysis have been performed, consumer characteristic data may be generated based on the face and hand analysis (operation 720). The consumer characteristic data is then compared with a plurality of program profiles associated with a plurality of different programs to recommend one or more programs (operation 722). For example, the consumer characteristic data may be compared with the program profiles to recommend one or more programs based on the gender and/or age of the consumer (operation 724). The consumer characteristic data may be compared with the program profiles to recommend one or more programs based on the identified consumer profile (operation 726). The consumer characteristic data may be compared with the program profiles to recommend one or more programs based on the identified facial expressions (operation 728). The consumer characteristic data may be compared with the program profiles to recommend one or more programs based on the identified hand gestures (operation 729). The method 700 also includes selecting one or more programs to present to the consumer based on a comparison of the recommended program profiles (operation 730). The selection of the program(s) may be based on a weighing and/or ranking of the various selection criteria 724, 726, 728, and 729. A selected program is then displayed to the consumer (operation 732).

The method 700 may then repeat starting at operation 710. The operations for selecting a program based on a captured image may be performed substantially continuously. Alternatively, one or more of the operations for selecting a program based on a captured image (e.g., facial analysis 512 and/or hand analysis 719) may be periodically run periodically and/or at an interval of a small amount of frames (e.g., 30 frames). This may be particularly suited for applications in which the program selection system 12 is integrated into platforms with reduced computational capacities (e.g., less capacity than personal computers).

The following is an illustrative example of one embodiment of a pseudo-code consistent with the present disclosure:

The pseudo-code of video capture and analyzer is as below.

```
Co-start:
  Thread 0 {
    For (each video frame) {
    Detect face in video:
    For (each detected face) {
      Compare it with faces in database:
      If (a new face) {
        Face_id = create (new face):
        Face_characteristics = face_analyzer(new face);
        Store face_id and face_characteristics into database;
      } else {
        Face_id = the matched face id in the database;
      }
      Log the current face id in a shared place with program
      recommender;
    }
    }
  }
  Thread 1 {
    For (each video frame) {
    Detect holding-still hand in video;
    For (each detected hand) {
      Compare it with predefined gestures in database;
      If (matched) {
        Call program_voter( );
      }
    }
    }
  }
Co-end;
```

While FIGS. 6 and 7 illustrate method operations according various embodiments, it is to be understood that in any embodiment not all of these operations are necessary. Indeed, it is fully contemplated herein that in other embodiments of the present disclosure, the operations depicted in FIGS. 6 and 7 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

As used in any embodiment herein, the term “module” refers to software, firmware and/or circuitry configured to perform the stated operations. The software may be embodied as a software package, code and/or instruction set or instructions, and “circuitry”, as used in any embodiment herein, may comprise, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), etc.

Certain embodiments described herein may be provided as a tangible machine-readable medium storing computer-executable instructions that, if executed by the computer, cause the computer to perform the methods and/or operations described herein. The tangible computer-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The computer may include any suitable processing platform, device or system, computing platform, device or system and may be implemented using any suitable combination of hardware and/or software. The instructions may include any suitable type of code and may be implemented using any suitable programming language.

Thus, in one embodiment the present disclosure provides a method for selecting a program to present to a consumer. The method includes detecting, by a face detection module, a facial region in the image; detecting, by a hand detection module, a hand gesture in an image; identifying, by the face and hand detection modules, one or more consumer characteristics based on the detected facial region and the detected hand gesture of the consumer; identifying, by a program selection module, one or more programs to present to the consumer based on a comparison of the consumer characteristics with a program database including a plurality of program profiles; and presenting, on a media device, a selected one of the identified program to the consumer.

In another embodiment, the present disclosure provides an apparatus for selecting a program to present to a consumer in an image. The apparatus includes a face detection module configured to detecting a facial region in the image and identify one or more consumer characteristics of the consumer in the image, a hand detection module configured to identify a hand gesture in an image and update the consumer characteristics, a program database including a plurality of program profiles, and a program selection module configured to select one or more programs to present to the consumer based on a comparison of the consumer characteristics with the plurality of program profiles.

In yet another embodiment, the present disclosure provides tangible computer-readable medium including instructions stored thereon which, when executed by one or more processors, cause the computer system to perform operations comprising detecting a facial region in an image; detecting a hand gesture in an image; identifying one or more consumer characteristics based on the detected facial region and detected hand gesture of the consumer; and identifying one or more programs to present to said consumer based on a comparison of said consumer characteristics with a program database including a plurality of program profiles.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

1. A method for selecting a program to present to a consumer, said method comprising:
detecting, by a face detection module, a facial region in an image;
detecting, by a hand detection module, a hand gesture in said image;
identifying, by said face and said hand detection modules, one or more consumer characteristics based on said detected facial region and said detected hand gesture of said consumer;
identifying, by a program selection module, one or more programs to present to said consumer based on a comparison of said consumer characteristics with a program database including a plurality of program profiles; and
presenting, on a media device, a selected one of said identified programs to said consumer.

2. The method of claim 1, wherein said consumer characteristics is selected from the group consisting of age, age classification, gender, and a facial expression of said consumer in said image.

3. The method of claim 1, wherein said consumer characteristics include data representative of a hand gesture.

4. The method of claim 3, further comprising identifying, by said face detection module, a consumer profile stored in a consumer profile database corresponding to said facial region in said image, wherein said consumer profile includes a viewing history of said consumer.

5. The method of claim 4, further comprising updating said consumer profile based on a correlation between said hand gesture and a program profile of a program being presented to said consumer.

6. The method of claim 1, wherein said consumer characteristics is selected from the group consisting of age, age classification, gender, a facial expression of said consumer in said image, and consumer characteristics include data representative of a hand gesture, and wherein said comparison of said consumer characteristics with said program database further comprises ranking of one or more of said age, age classification, gender, said consumer profile, and said facial expression of said consumer.

7. The method of claim 4, further comprising transmitting at least a portion of said consumer profile to a content provider.

8. An apparatus for selecting a program to present to a consumer, said apparatus comprising:
a face detection module configured to detect a facial region in an image and identify one or more consumer characteristics of said consumer in said image;
a hand detection module configured to identify a hand gesture in said image and update said consumer characteristics;
a program database including a plurality of program profiles; and
a program selection module configured to select one or more programs to present to said consumer based on a comparison of said consumer characteristics with said plurality of program profiles.

9. The apparatus of claim 8, wherein said consumer characteristics is selected from the group consisting of age, age classification, gender, and a facial expression of said consumer in said image.

10. The apparatus of claim 8, wherein said face detection module is further configured to identify a consumer profile stored in a consumer profile database corresponding to said facial region in said image, wherein said consumer profile includes a viewing history of said consumer.

11. The apparatus of claim 8, wherein said program selection module is further configured to update said consumer profile based on a correlation between said hand gesture and a program profile of a program being presented to said consumer.

12. The apparatus of claim 8, wherein said consumer characteristics comprise at least one facial expression of said consumer in said image.

13. The apparatus of claim 9, wherein said consumer characteristics is selected from the group consisting of age, age classification, gender, a facial expression of said consumer in said image, and consumer characteristics include data representative of a hand gesture, and wherein said program selection module is further configured to compare said consumer characteristics with said program database based on a ranking of one or more of said age, age classification, gender, said consumer profile, said facial expression, and said hand gesture of said consumer.

14. The apparatus of claim 11, wherein said system is configured to transmit at least a portion of said consumer profile to a content provider.

15. A tangible computer-readable medium including instructions stored thereon which, when executed by one or more processors, cause the computer system to perform operations comprising:
detecting a facial region in an image;
detecting a hand gesture in said image;
identifying one or more consumer characteristics based on said detected facial region and said detected hand gesture of said consumer; and
identifying one or more programs to present to said consumer based on a comparison of said consumer characteristics with a program database including a plurality of program profiles.

16. The tangible computer-readable medium of claim 15, wherein said identified consumer characteristics comprise at least one of an age, age classification, a gender, and at least one facial expression of said consumer in said image.

17. The tangible computer-readable medium of claim 15, wherein the instructions that when executed by one or more of the processors result in the following additional operations comprising:
identifying a consumer profile stored in a consumer profile database corresponding to said facial region in said image, wherein said consumer profile includes a viewing history of said consumer.

18. The tangible computer-readable medium of claim 15, wherein said consumer characteristics is selected from the group consisting of age, age classification, gender, a facial expression of said consumer in said image, and consumer characteristics include data representative of a hand gesture, and wherein the instructions that when executed by one or more of the processors result in the following additional operations comprising ranking of one or more of said age, age classification, gender, said consumer profile, and said facial expression of said consumer.

19. The tangible computer-readable medium of claim 17, wherein the instructions that when executed by one or more of the processors result in the following additional operations comprising:
updating said consumer profile based on a correlation between said hand gesture and a program profile of a program being presented to said consumer.
